(19) United States
(12) Patent Application Publication
(10) Pub. No.: US 2006/0033969 A1
(43) Pub. Date: Feb. 16, 2006

(54) Medium feeding apparatus, document feeding apparatus, and paper feeder

(75) Inventor: Hisaya Ishio, Toda-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/201,431

(22) Filed: Aug. 11, 2005

(30) Foreign Application Priority Data
Aug. 13, 2004 (JP) 2004-235953

(51) Int. Cl. H04N 1/04

(52) U.S. Cl. 358/498

(57) ABSTRACT

An automatic document feeder includes a setting section on which a document is set, a feeding device which feeds the document set on the setting section to an image reading section, a plurality of projecting indicating sections which indicate respective setting positions for the document to be set on the setting section, a document guide which is provided on the setting section to be movable in a direction perpendicular to a direction of feeding the document, and guides the document when the document is fed, and a positioning projecting portion which is provided on the document guide, and to be opposed to a desired indicating section among the plurality of indicating sections by moving the document guide, to position the document guide to the desired indicating section.

### CROSS-REFERENCE TO RELATED APPLICATIONS

This application is based upon and claims the benefit of priority from prior Japanese Patent Application No. 2004-235953, filed Aug. 13, 2004, the entire contents of which are incorporated herein by reference.

### BACKGROUND OF THE INVENTION

1. Field of the Invention

The present invention relates to a medium feeding apparatus, a document feeding apparatus and a paper feeder, which are provided in an image forming apparatus and feed media such as original documents and paper to to-be-fed sections.

2. Description of the Related Art

Medium feeding apparatuses of this type, for example, automatic document feeders, are configured to be provided on a document glass on a top surface portion of the main body of an image forming apparatus, and automatically carry a document onto the original glass.

Automatic document feeders have a document setting table on which a document is set, and a formation surface forming a plurality of indicating sections for indicating respective setting positions of documents of various sizes to be set on the document setting table. The indicating sections are formed in parallel with one another at predetermined intervals in a direction perpendicular to a document feeding direction. Further, the document setting table is provided with a document guide which is movable in a direction perpendicular to the document feeding direction.

The document is set on the document setting table in line with the indicating section corresponding to the size of the document, and side portions of sheets of the document are aligned by a document guide. In this state, the document is fed by operation of the feeding mechanism, and fed into a proper position on the document glass since it is guided by the document guide when fed (for example, see Jpn. Pat. Appln. KOKAI Pub. No. 10-35956).

However, in prior art, the indicating sections indicating the document setting positions are formed to be flush with the formation surface. This structure causes a problem that it is difficult for visually-impaired users to recognize a desired indicating section and position the document guide to the desired section.

### BRIEF SUMMARY OF THE INVENTION

The present invention has been made in view of the above circumstances. The object of the present invention is to provide a medium feeding apparatus which enables visually-impaired users to easily position the document guide to a desired indicating section.

According to an aspect of the present invention, a medium feeding apparatus comprises: a setting section on which a medium is set; a feeding device which feeds the medium set on the setting section to a section to be fed with the medium; a plurality of projecting indicating sections which indicate respective setting positions for the medium set on the setting section; a medium guide which is provided on the setting section to be movable in a direction perpendicular to a direction of feeding the medium, and guides the medium when the medium is fed; and a positioning projecting portion which is provided on the medium guide, and to be opposed to a desired indicating section among the plurality of indicating sections by moving the medium guide, to position the medium guide to the desired indicating section.

According to an aspect of the present invention, the medium guide can be positioned to a desired indicating section indicating a setting position of a medium on the basis of tactile sense, not by visual check. This allows visually-impaired users to easily position the medium guide.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external perspective view of an image forming apparatus according to an embodiment of the present invention.

FIG. 2 is a perspective view of an automatic document feeder of the image forming apparatus shown in FIG. 1.

FIG. 3 is a perspective view of a document guide of the automatic document feeder shown in FIG. 2.

FIG. 4 is a perspective view illustrating a state where the document guide shown in FIG. 3 is moved and positioned.

FIG. 5 is a perspective view of a document guide according to another embodiment of the present invention.

FIG. 6 is a perspective view of an indicating device according to another embodiment of the present invention.

### DETAILED DESCRIPTION OF THE INVENTION

The present invention will be detailed with reference to embodiments illustrated in the drawings.

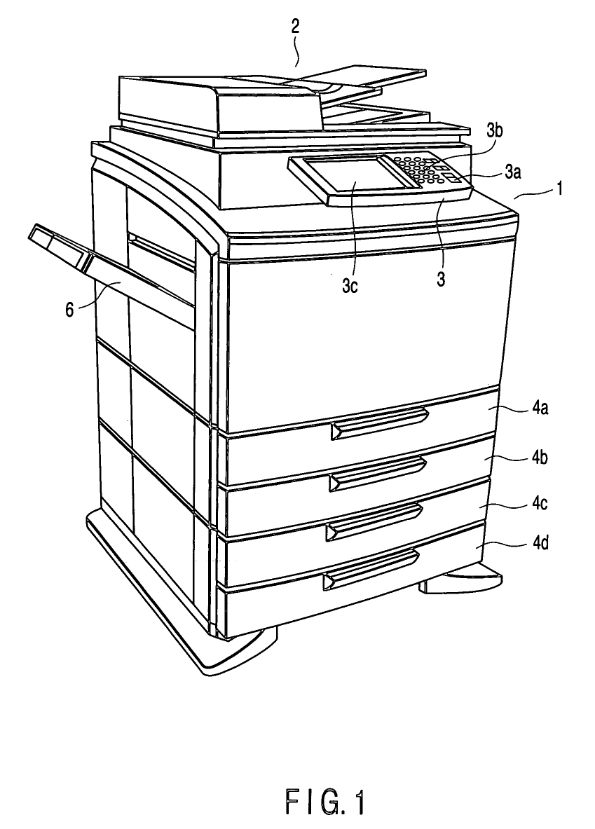

FIG. 1 is an external perspective view of a digital copying machine serving as an image forming apparatus according to an embodiment of the present invention.

The digital copying machine comprises a main body 1. A document glass (not shown) on which a document serving as a medium is to be set is provided in a top surface portion of the main body 1. An automatic document feeder 2 which automatically feeds a document onto the document glass is provided on the document glass.

An operation section 3 is provided in front of the automatic document feeder 2. The operation section 3 is provided with a copying button 3a, a ten-key numeric pad 3b, and an information display window 3c, etc.

A publicly-known image forming mechanism (not shown) is provided inside the main body 1. The image forming mechanism has an image reading section (scanner) which reads images of a document set on the document glass, and an exposure section which exposes a photosensitive drum to light on the basis of image information read by the image reading section (scanner) and forms an electrostatic latent image. The image forming mechanism also has a developing section which develops the electrostatic latent image formed by the exposure section by supplying toner to the image, and a transfer section which transfers the toner image developed by the developing section to paper.

A plurality of paperfeed cassettes 4a to 4d to feed paper of various sizes are arranged in a stacked state in a bottom portion of the main body 1. The paperfeed cassette 4a stores A4 sheets, and the paperfeed cassette 4b stores B5 sheets. The paperfeed cassette 4c stores B4 sheets, and the paperfeed cassette 4d stores A3 sheets.

Further, an output tray 6 is provided on one side surface of the main body 1. The output tray 6 receives outputted paper with the image formed. A manual feed tray (not shown) which allows manual feed of paper is provided on the other side surface of the main body 1.

Each sheet of paper fed from the paperfeed cassettes 4a to 4d or the manual feed tray is carried between the photosensitive drum and the transfer section, and outputted onto the output tray 6 after a toner image on the photosensitive drum is transferred to the sheet.

Next, the above automatic document feeder 2 is detailed below.

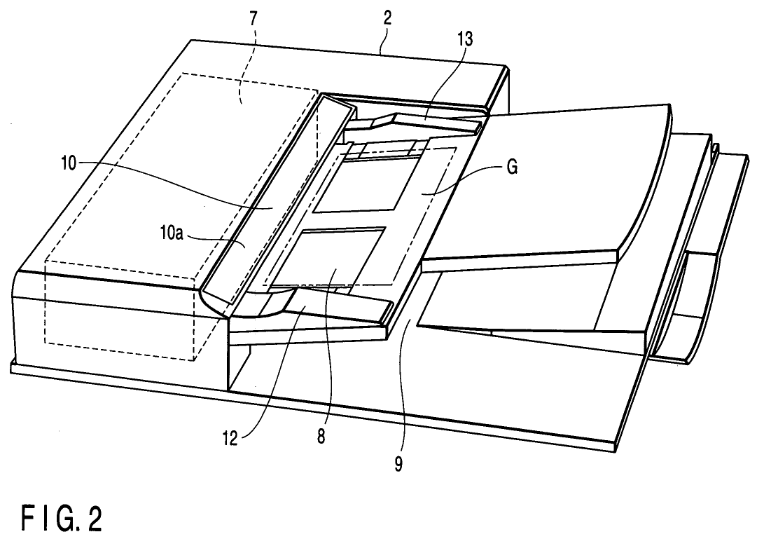

FIG. 2 is a perspective view illustrating the automatic document feeder 2.

The automatic feeder 2 has a document setting table 8 on which a document G is set, and a carrying mechanism 7 serving as a feeding device which takes and carries the document set on the document setting table 8 onto the document glass, and then carries it out of the document glass. The automatic document feeder 2 also has a document receiving section 9 which receives the document carried out by the carrying mechanism 7, and an indicating device 10 which indicates setting positions of the document to be set on the document setting table 8.

On the document setting section 8, provided are document guides 12 and 13 serving as a pair of medium guides, which are arranged apart from and opposed to each other and movable in a direction perpendicular to a document feeding direction. The document guides 12 and 13 align sheets of the document set on the document setting table 8 such that the document is carried in a proper position, and guide the sheets when the document is fed. The document guides 12 and 13 are configured to be movable in a direction in which they come close to or away from each other.

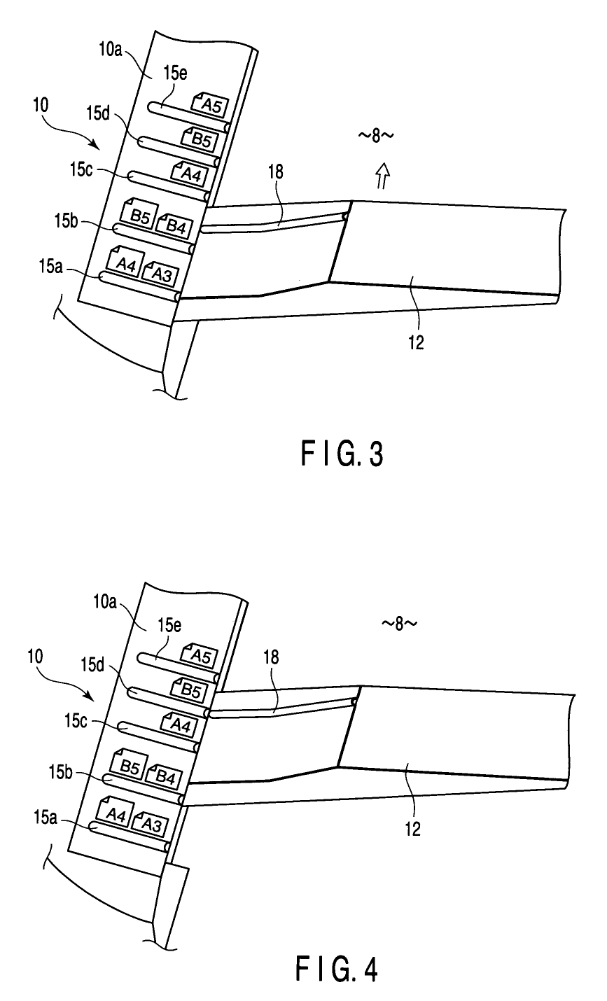

The indicating device 10 has a formation surface 10a on which first to fifth indicating sections 15a to 15e are formed to indicate respective setting positions of documents of various sizes, as shown in FIG. 3. The first indicating section 15a indicates setting positions of a document of A4 size in portrait orientation, and a document of A3 size in landscape orientation.

The second indicating section 15b indicates setting positions of a document of B5 size in portrait orientation, and a document of B4 size in landscape orientation. The third indicating section 15c indicates a setting position of a document of A4 size in landscape orientation, the fourth indicating section 15d indicates a setting position of a document of B5 size in landscape orientation, and the fifth indicating section 15e indicates a setting position of a document of A5 size in landscape orientation.

The first to fifth indicating sections 15a to 15e form respective projections, and are arranged in parallel at predetermined intervals in the moving direction of the document guide 12.

Further, a projecting member 18 serving as a positioning projecting portion is provided as one unitary piece on a top surface portion of the original guide 12. The positioning projecting member 18 has almost the same height as that of the first to fifth indicating sections 15a to 15e.

Next, positioning the above document guide 12 to a desired indicating section (15a to 15e) is explained.

For example, suppose that a document of B5 size is to be set in landscape orientation. First, the document of B5 size is set in landscape orientation on the document setting table 8, in the state where the document guide 12 is located outside the fourth indicating section 15d, as shown in FIG. 3. Then, the document guide 12 in this position is moved in the direction of an arrow shown in FIG. 3, and an end portion of the projecting member 18 is opposed to an end portion of the fourth indicating section 15d to align the fourth indicating section 15d with the projection member 18, as shown in FIG. 4. Thereby, the document guide 12 is positioned to the proper setting position for documents of B5 size in landscape orientation.

As described above, according to this embodiment, the indicating sections 15a to 15e indicating the document setting positions are formed to have a projection shape, and the positioning projecting member 18 is formed on the document guide 12. The document guide 12 is positioned by aligning an end portion of the positioning projecting member 18 with an end portion of the indicating section 15a (to 15e) indicating the setting position of the document of desired size. This structure enables even visually-impaired users to easily position the document guide 12, since it allows the users to perceive by tactile sense that the projecting indicating section 15a (to 15e) is aligned with the positioning projecting member 18.

Further, the indicating sections 15a to 15e and the positioning projecting member 18 are formed to have a projection shape in such a manner that they have almost the same height. Therefore, the user can smoothly move the fingertip along the indicating section 15a (to 15e) and the positioning projecting member 18, and can easily perceive that they are aligned.

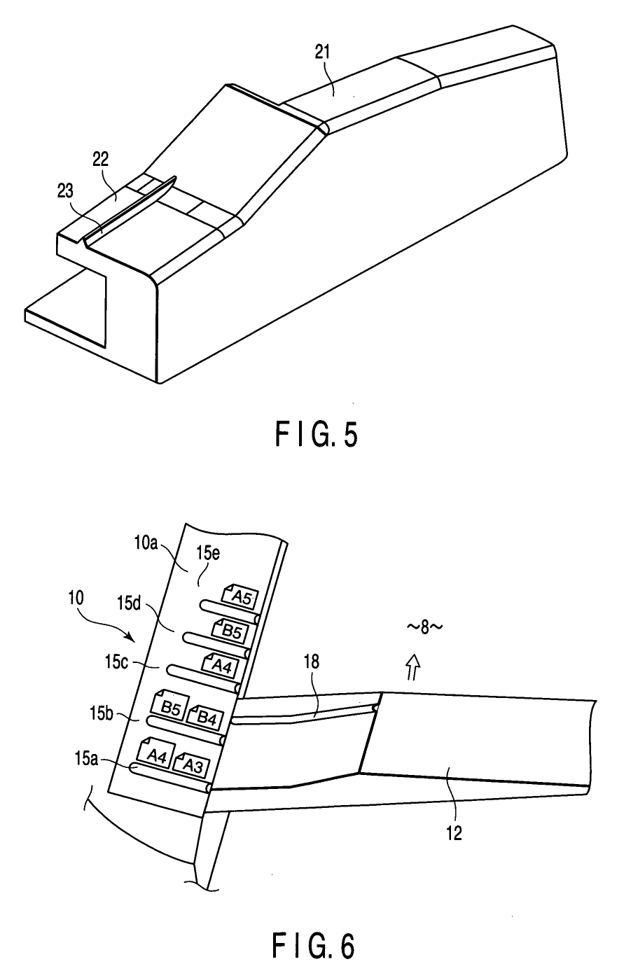

FIG. 5 is a perspective view of a document guide 21 according to another embodiment of the present invention.

A holding portion 22 is provided on a top surface of a distal end portion of the document guide 21 as one unitary piece with the document guide 21. A projecting member 23 serving as a positioning projecting portion is provided on a top surface portion of the holding portion 22. The holding portion 22 holds a document of a predetermined number of sheets set on the document setting table by pressing it from the top surface side to suppress rise of the document.

Further, although the medium feeding apparatus of the present invention is applied to the document feeder 2 in the above embodiments, the present invention is not limited to it, but may be applied to a manual feeder. Furthermore, it may be applied to the paperfeed cassettes 4a-4d.

Further, although the first to fifth indicating sections 15a to 15e have the same length in the above embodiments, the present invention is not limited to it, but the first to fifth indicating sections 15a to 15e have different lengths as shown in FIG. 6. This structure enables the user to distinguish the document sizes indicated by the first to fifth indicating sections 15a to 15e from one another more easily.

Moreover, Braille characters may be formed in the vicinity of the first to fifth indicating sections 15a to 15e to enable the user to perceive the document sizes of the first to fifth indicating sections 15a to 15e by the Braille characters.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A medium feeding apparatus comprising:
a setting section on which a medium is set;
a feeding device which feeds the medium set on the setting section to a section to be fed with the medium;
a plurality of projecting indicating sections which indicate respective setting positions for the medium set on the setting section;
a medium guide which is provided on the setting section to be movable in a direction perpendicular to a direction of feeding the medium, and guides the medium when the medium is fed; and
a positioning projecting portion which is provided on the medium guide, and to be opposed to a desired indicating section among the plurality of indicating sections by moving the medium guide, to position the medium guide to the desired indicating section.

2. A medium feeding apparatus according to claim 1, wherein the plurality of indicating sections form projections, and arranged in parallel at predetermined intervals in a direction of moving the medium guide.

3. A medium feeding apparatus according to claim 2, wherein the positioning projecting portion of the medium guide is formed to have a projection shape on a top surface portion of the medium guide, and aligned with one of the projecting indicating sections when opposed to one of the projecting indicating sections.

4. A medium feeding apparatus according to claim 2, wherein the plurality of indicating sections have lengths different from one another.

5. A medium feeding apparatus according to claim 3, wherein the positioning projecting portion has almost the same height as that of the indicating sections.

6. A medium feeding apparatus according to claim 1, wherein the medium guide has a holding portion which presses and holds media if a predetermined number of sheets of media are set in a stacked state on the setting section, from a top surface portion side to suppress rising of the media, and the positioning projecting portion is formed on a top surface portion of the holding portion.

7. A document feeding apparatus comprising:
a setting section on which a document is set;
a feeding device which feeds the document set on the setting section to an image reading section;
a plurality of projecting indicating sections which indicate respective setting positions for the document to be set on the setting section;
a document guide which is provided on the setting section to be movable in a direction perpendicular to a direction of feeding the document, and guides the document when the document is fed; and
a positioning projecting portion which is provided on the document guide, and to be opposed to a desired indicating section among the plurality of indicating sections by moving the document guide, to position the document guide to the desired indicating section.

8. A document feeding apparatus according to claim 7, wherein the plurality of indicating sections form projections, and arranged in parallel at predetermined intervals in a direction of moving the document guide.

9. A document feeding apparatus according to claim 8, wherein the positioning projecting portion is formed to have a projection shape on a top surface portion of the document guide, and aligned with one of the projecting indicating sections when opposed to one of the projecting indicating sections.

10. A document feeding apparatus according to claim 8, wherein the plurality of indicating sections have lengths different from one another.

11. A document feeding apparatus according to claim 9, wherein the positioning projecting portion has almost the same height as that of the indicating sections.

12. A document feeding apparatus according to claim 7, wherein the document guide has a holding portion which presses and holds the document of a predetermined number of sheets set in a stacked state on the setting section, from a top surface portion side to suppress rising of the document, and the positioning projecting portion is formed on a top surface portion of the holding portion.

13. A paper feeder comprising:
a setting section on which paper is set;
a feeding device which feeds the paper set on the setting section to a section to be fed with the paper;
a plurality of projecting indicating sections which indicate respective setting positions for the paper set on the setting section;
a paper guide which is provided on the setting section to be movable in a direction perpendicular to a direction of feeding the paper, and guides the paper when the paper is fed; and
a positioning projecting portion which is provided on the paper guide, and to be opposed to a desired indicating section among the plurality of indicating sections by moving the paper guide, to position the paper guide to the desired indicating section.

14. A paper feeder according to claim 13, wherein the plurality of indicating sections form projections, and arranged in parallel at predetermined intervals in a direction of moving the paper guide.

15. A paper feeder according to claim 14, wherein the positioning projecting portion of the paper guide is formed to have a projection shape on a top surface portion of the paper guide, and aligned with one of the projecting indicating sections when opposed to one of the projecting indicating sections.

16. A paper feeder according to claim 14, wherein the plurality of indicating sections have lengths different from one another.

17. A paper feeder according to claim 15, wherein the positioning projecting portion has almost the same height as that of the indicating sections.

18. A paper feeder according to claim 13, wherein the paper guide has a holding portion which presses and holds paper of a predetermined number of sheets set in a stacked state on the setting section, from a top surface portion side to suppress rising of the paper, and the positioning projecting portion is formed on a top surface portion of the holding portion.
